(19) United States
(12) Patent Application Publication
(10) Pub. No.: US 2018/0325094 A1
(43) Pub. Date: Nov. 15, 2018

(54) LIVE CATCH ANIMAL TRAP

(71) Applicant: AP&G Co., Inc., Bayonne, NJ (US)

(72) Inventor: Edward William Dolshun, Warwick, NY (US)

(21) Appl. No.: 15/975,430

(22) Filed: May 9, 2018

Related U.S. Application Data
(60) Provisional application No. 62/503,725, filed on May 9, 2017.

(51) Int. Cl. A01M 23/20

(52) U.S. Cl. CPC A01M 23/20; A01M 23/18

(57) ABSTRACT

A trap for attracting and capturing animals without injury. The trap is a walled chamber that has an opening for animals to enter. A trigger plate located in the rear of the trap is set to lower a trap door once stepped on by an animal. A hook used to hold the trap door in a raised position is provided with a thumb assist interface allowing a user to easily set and the trap with the assistance of a finger such a thumb. The trap also is provided with a separately accessible bait chamber which allows a user to add bait to the trap without having to insert a hand into the trap chamber.

### FIELD OF THE INVENTION

The invention relates to the field of animal traps, more specifically to animal traps that are provided with improved setting and baiting features.

### BACKGROUND OF THE INVENTION

Animal traps are widely used by homeowners and pest control professionals to capture unwanted small animals for removal and release. Such traps are required to trap attract small animals and then trap them alive and unharmed.

Live catch traps known in the art are difficult to set and they pose a danger of closing on an operator's hand while baiting the trap. There is therefore a need in the art for a live catch trap that may be set in a convenient manner and which does not require a user to insert his/her hand into the confines of the trap for the purpose of adding bait.

### SUMMARY OF THE INVENTION

In embodiments of the invention, a trap is provided having an inner chamber for capturing small animals or rodents. An entrance is provided on one side of the trap, which allows access to the interior chamber. A trap door is provided that is configured to close once an animal enters the trap in order to prevent the animal from exiting the trap. The trap door is configured to be temporarily maintained in an open position when the trap is set. The door is further configured to automatically close when an animal enters the confines of the trap and steps on a trigger plate that is linked to the door.

In embodiments of the invention, a hook or similar catch is provided in an area near the top of the inside of the trap for holding the door in a raised, open position.

In embodiments of the invention, the hook is configured to be movable by a user's thumb for purposes of engaging the hook to grasp the trap door for ease of setting.

In other embodiments of the invention, a lock, latch or similar retaining mechanism is provided to lock the hook in place in order to prevent accidental closing of the door when releasing an animal.

Still in other embodiments of the invention, a bait chamber is provided in a lower segment of the trap that is accessible by way of a second door on the bottom surface of the trap. Thus, a user need only open this bait chamber door and insert bait therein—without having to reach his/her arm into the trap.

The invention further provides for a novel method of setting a trap by allowing a user to raise a trap door and then conveniently engage a hook to move laterally and capture a bar or similar structure associated with the trap door.

The invention still further provides a novel method of baiting a trap by allowing a user to open a door that leads to a bait chamber and insert bait into the chamber. This obviates the need for an operator to insert his/her hand into the interior of the trap in order to add bait.

### BRIEF DESCRIPTION OF THE DRAWINGS

FIG. 1 is a side perspective view of a trap shown in a closed configuration according to an exemplary embodiment of the invention.

FIG. 2 is an enlarged partial side view of the trap of FIG. 1 according to an exemplary embodiment of the invention.

FIG. 3 is an enlarged partial side view of the trap of FIG. 1 according to an exemplary embodiment of the invention.

FIG. 4 is an enlarged partial side view of the trap of FIG. 1 shown in an open configuration according to an exemplary embodiment of the invention.

FIG. 5 is a partial front perspective view of a trap door secured in an open configuration according to an exemplary embodiment of the invention.

FIG. 6 is a partial bottom perspective view of a trap showing a bait chamber with its door in an open configuration according to an exemplary embodiment of the invention.

### DETAILED DESCRIPTION OF THE FIGURES AND INVENTIONS

Embodiments of the present invention will now be described with reference to the below-identified drawings and photographs. However, the drawings, photographs, and the description of the invention are not intended to limit the scope of the invention. It will be understood that various modifications of the present description of the invention are possible without departing from the spirit of the invention. Also, features or steps described herein may be omitted, additional steps or features may be included, and/or features or steps described herein may be combined in a manner different from the specific combinations recited herein without departing from the spirit of the invention, all as understood by those of skill in the art.

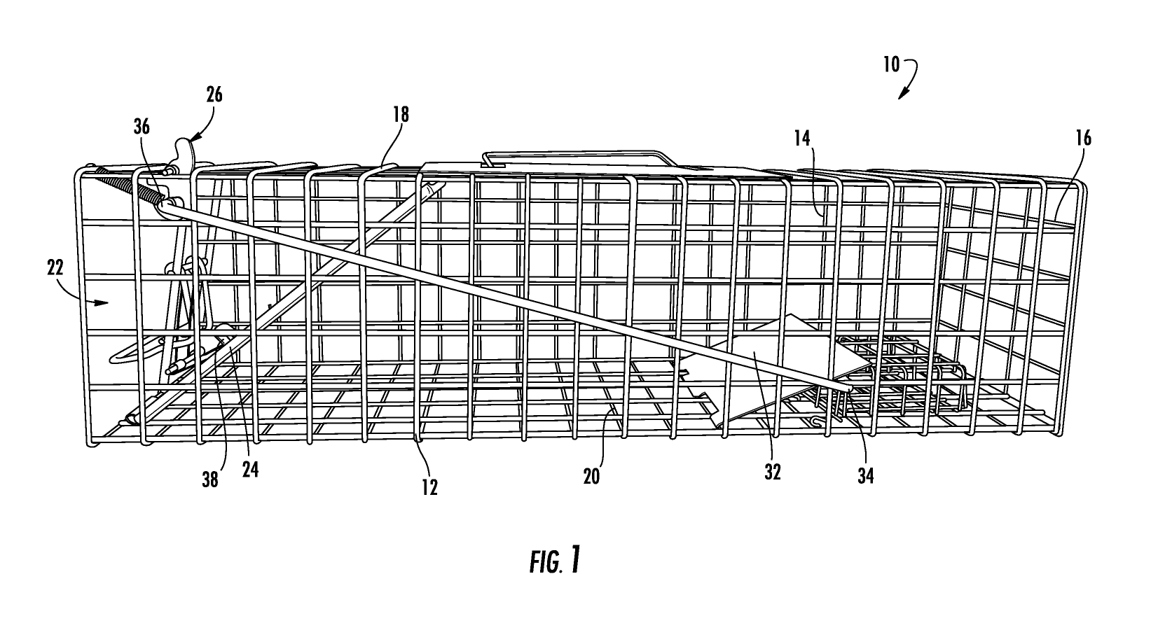

FIG. 1 shows a side view of an animal trap according to an embodiment of the invention. As shown, the trap 10 is formed by a series of connected bars which form a first side wall 12, an opposing side wall 14, a rear wall 16, a top wall 18, and a bottom wall 20. These walls define an enclosed trap chamber. In embodiments of the invention, a front end of the trap has an opening 22—which is configured to be covered or blocked by a hinged door 24. In the configuration shown in FIG. 1, door 24 is in a lowered position blocking egress out of the interior of the trap 10.

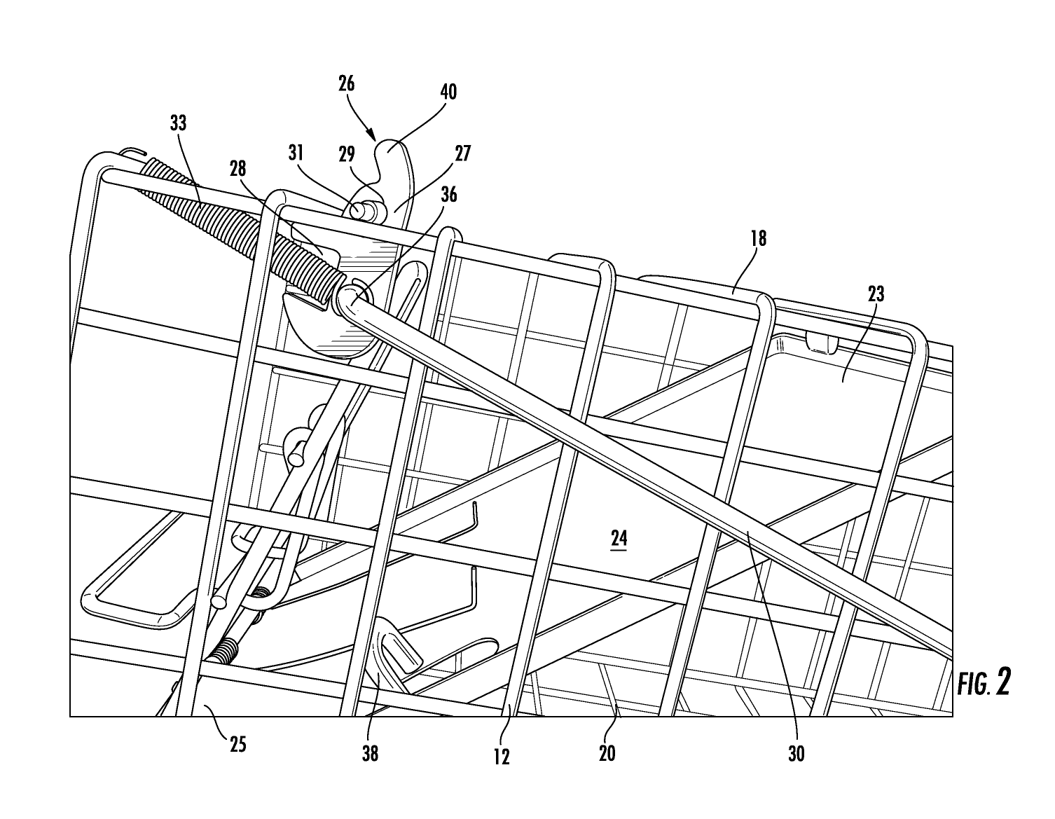

FIG. 2 shows an enlarged partial side view of door 24 and associated securing mechanisms. As in FIG. 1, door 24 is shown in a closed position whereby it is configured to block access to the trap opening 22. As shown, door 24 is a panel having a first end 23 that is hingedly connected to an underside of top wall 18, and a second end 25 that contacts the floor of the trap 10. In embodiments of the invention, in the closed position, door 24 is angled diagonally between a segment of top wall 18 and bottom wall 20; however, it will be understood that closed door 24 may be disposed in other orientations or positions in different embodiments of the invention.

It will be understood that first end 23 of door may be pivotably mounted to any of various areas proximate to top wall 18, including above, below or within top wall 18.

In embodiments of the invention, door 24 is biased toward a closed (i.e. lowered) position, but the bias may be overcome for the purpose of setting the trap. For example, in embodiments of the invention, first end 23 is connected via one more hinges to the top wall 18, such that second end 25 is free to fall downward under the force of gravity. In this regard, second end 27 by default will fall to a closed position unless such it is secured by a fastener or similar temporary restraining mechanism. In other embodiments of the invention, door 24 is spring-biased in a closed position.

Trap 10 includes a temporary securement mechanism to temporarily maintain door 24 in a raised position against its bias. When the door 24 is so raised, the entrance 22 to the trap 10 is unobstructed and an animal may enter into the interior confines of the trap 10. Trap 10 is “set” when door 24 is temporarily secured in a raised position.

For example, in embodiments of the invention, a hook 26 or similar catch is provided to secure the door 24 in an open position. For example, as shown in FIGS. 2-4, a hook 26 is mounted near or on the top wall 18 of the trap 10. As shown, hook 26 a shank section 27 and a slot or similar pocket 28. A hole 29 formed in an upper segment of shank section 27 of hook is sized and shaped to receive a shank of an axle 31. Hook 26 is installed on the axle 31 such that it is pivotable in two directions.

In embodiments of the invention, at least a segment of hook 26 projects downward into the interior of the trap 10. In this regard, pocket 28 of hook 26 is positioned to receive a segment of door 24 and maintain the door 24 in a raised position substantially parallel to top wall 18.

In embodiments of the invention, hook 26 is positioned such that pocket 28 faces the opening 22 of the trap 10. In a preferred embodiment, hook 26 is pivotable about the axis of axle 31 such that the lower segment may be pivoted forward and backward (e.g. in a direction toward opening 22 and in the opposite direction away from opening 22). For instance, in the orientation shown in FIGS. 1-4, hook 26 is pivotable to the left (i.e. in the direction toward the front of the trap) in order to engage the door 24, and it is pivotable to the right (i.e. in the direction toward the rear wall 16 of the trap) in order to release the door 24.

With reference to FIG. 1, a treadle or similar trigger plate 32 is hingedly mounted on or proximate to the bottom wall 20 of the trap 10. A first end of the trigger plate is mounted to the bottom wall 20 by way of a hinge or similar pivotable structure. When the trap 10 is set, trigger plate 32 is oriented at angle with respect to the bottom wall 20. For example, as shown, a first end of the trigger plate is located on or close to the bottom wall 20 and a second end of the trigger plate 32 is angled upward and project into the space of the trap chamber.

In embodiments of the invention, a cross bar 30 is disposed between hook 26 and the trigger plate 32 linking the two. As shown, crossbar 30 has a first end 34 that is connected to trigger plate 32 and a second end 36 that is connected to hook 26. For example, as shown second end 36 of crossbar 30 turns at approximately 90° and inserts through a lower hole in shaft segment 27 of hook 26. As such, forward and rearward movement of crossbar 30 causes similar forward and rearward movement of hook 26. In embodiments of the invention, a spring 33 connected to second end 36 of crossbar 30 biases crossbar 30 in the direction toward the opening 22 of the trap 10. As a result, hook 26 also is so biased and trigger plate 32 is biased in a raised, set position (as shown in FIG. 1).

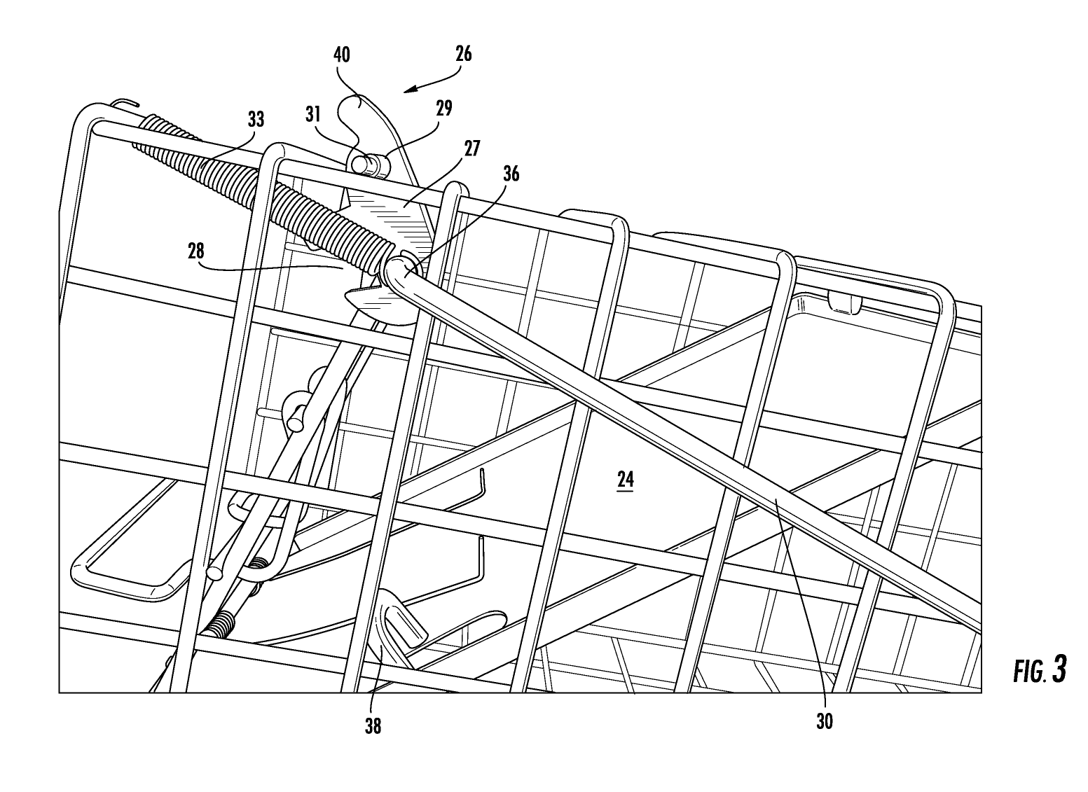

As shown in FIGS. 2 and 3 a substantially U-shaped bar 38 extending from or connected to door 24 has a substantially horizontal segment that is sized and shaped to insert into pocket 28 of hook 26. In this manner, when door 24 is raised and bar 38 inserts into the pocket 28 of hook 26, door 24 is maintained in an open/raised position.

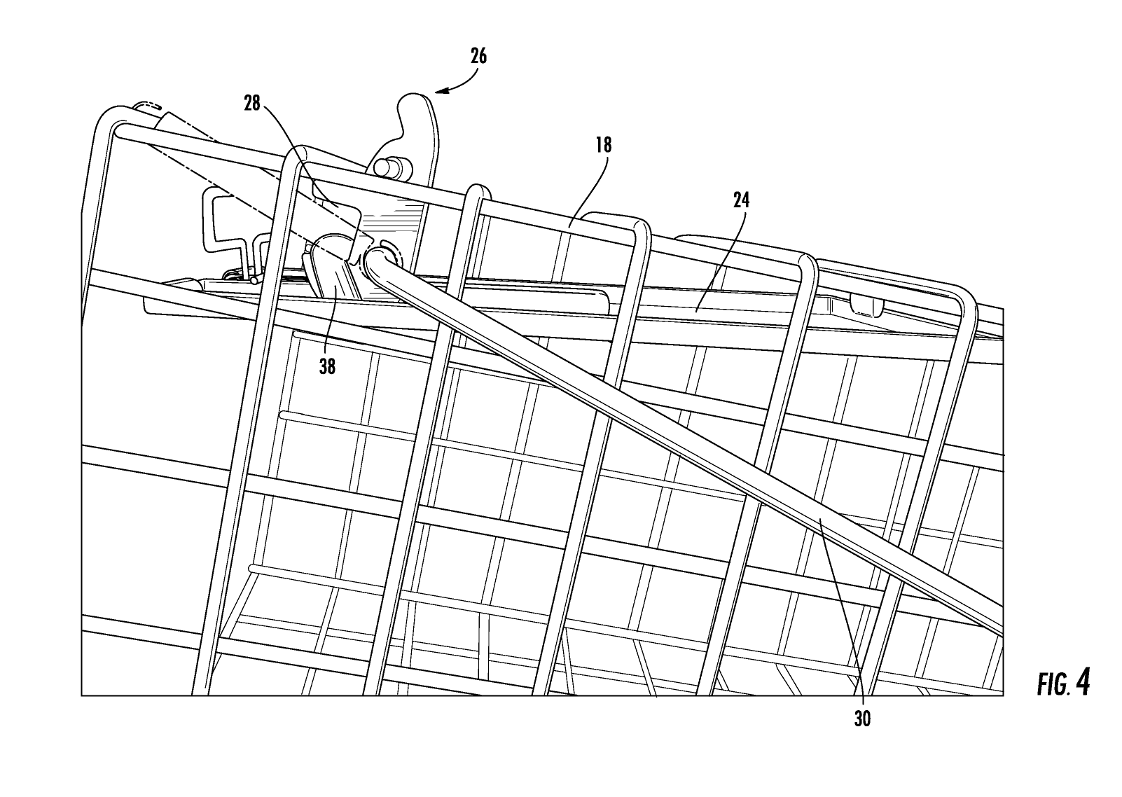

FIG. 4 shows an enlarged view of hook 26 maintaining door 24 in an open position. As shown, bar 38 is retained within pocket 28 of hook 26. In this regard, in an embodiment of the invention, trap 10 is set by manually raising second end 25 of door 24 such that bar 38 is substantially parallel to pocket 28 of hook 26. Hook 26 is then pivoted to a first position (e.g. in the direction toward the opening of the trap) to capture bar 38 associated with door 24. In such configuration, door 24 is temporarily raised and temporarily stored along the underside of top wall 18. With the door 24 maintained in a raised/open position, the trap 10 is set and ready to receive a rodent or small animal. It will be understood that hook 26 may similarly be pivoted in a direction toward rear wall 16 to a second position in order to release the door 24.

In a preferred embodiment, and for example as best shown in FIGS. 2-4, a projection 40 extends upwardly from a top of hook 26. Projection 40 forms a thumb-assist interface, whereby a user may place a finger (e.g. thumb) on the projection 40 in order to urge the hook 26 to pivot in either direction (e.g., the first position or second position referred to above). Thus, in order to set the trap, a user raises the door 24 to an open position, places a thumb on the projection 40 and applies pressure that moves the hook 26 in the desired direction, e.g., if the thumb moves the projection 40 toward the rear of the trap, the hook 26 will pivot forward into the first position in order to set the bar 38 within pocket 28, and vice versa.

It will be understood that projection 40 may be any of various sized or shaped features extending from hook 26 to accommodate a user's finger. In a preferred embodiment, and as shown, projection 40 has an elongated aspect which serves additionally serves as a lever to increase leverage on the fulcrum (i.e. the center through which axle 31 passes), thereby making it easier for a user to pivot the hook 26. In embodiments of the invention, projection 40 extends a sufficient distance away from the top of hook 26 to serve act as a lever as described.

In the event that an animal enters the interior chamber of the trap and steps on the trigger plate 32, crossbar 30 is urged in a direction toward the rear of the trap 10. As a result, hook 26 connected to cross bar 30 pivots to the second position (in a direction toward the rear of the trap). In embodiments of the invention, trigger plate 32 is configured to move a sufficient distance to cooperatively pivot hook 26 a sufficient distance in the direction away from opening 22 to allow bar 38 to fall out of the pocket 28. As a result, the door 24 falls into a closed position blocking egress from the trap. Thus, once animal traverses a far enough distance into the trap to step on trigger plate, it will become trapped within the chamber.

In embodiments of the invention a safety feature is provided to lock the door 24 in an open position against its bias, which is useful for example, when releasing an animal from the trap. In embodiments of the invention a movable barrier is provided to engage with hook 26, projection 40, or both to prevent it from pivoting into the second position. For example, a rotatable bar (not shown) positioned behind hook 26 may be rotated from a first position out of contact with hook 26 to a second position substantially aligned with the rear surface of hook 26. The bar, so positioned, serves as a physical barrier preventing movement of the hook 26 toward the rear of the trap. As such, door 24 held in a raised position by hook 26 will not be closable so long as the bar behind the hook 26 is engaged. In other embodiments, a wire or a catch connected near the hook is movable to contact and capture the hook 26 so as to maintain it place.

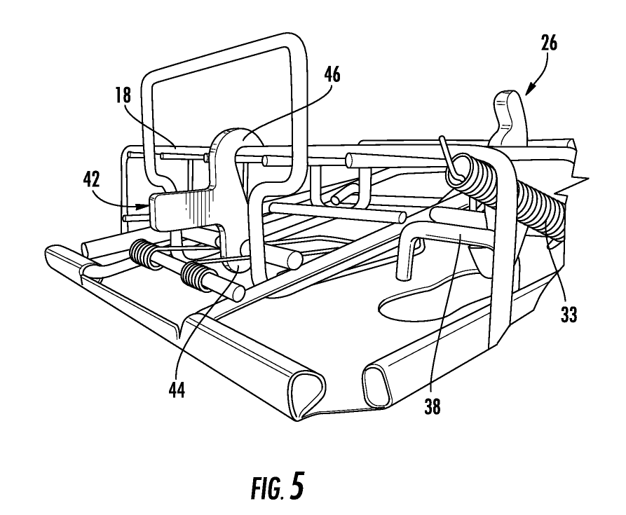

For example, with reference to FIG. 5 a secondary hook 42 is has a lower aspect 44 pivotably mounted to a bar or similar member connected to door 24. Secondary hook 42 has an upper hook segment 46 that is configured to capture a bar or similar segment of top wall 18 of the trap. In use, a user may lift door 24 to a raised position and then pivot secondary hook to capture a bar running across upper wall 18 of the trap. This ensures that door 24 remains open even if the trigger plate 32 is engaged by an animal. A user may, as such, secure door 24 open when releasing an animal from the interior chamber.

In embodiments of the invention, trap 10 is provided with a separate bait chamber having its own an access door. In this regard, a user need not insert his/her hand into the interior chamber of the trap, but rather simply insert bait through open access door into the bait chamber.

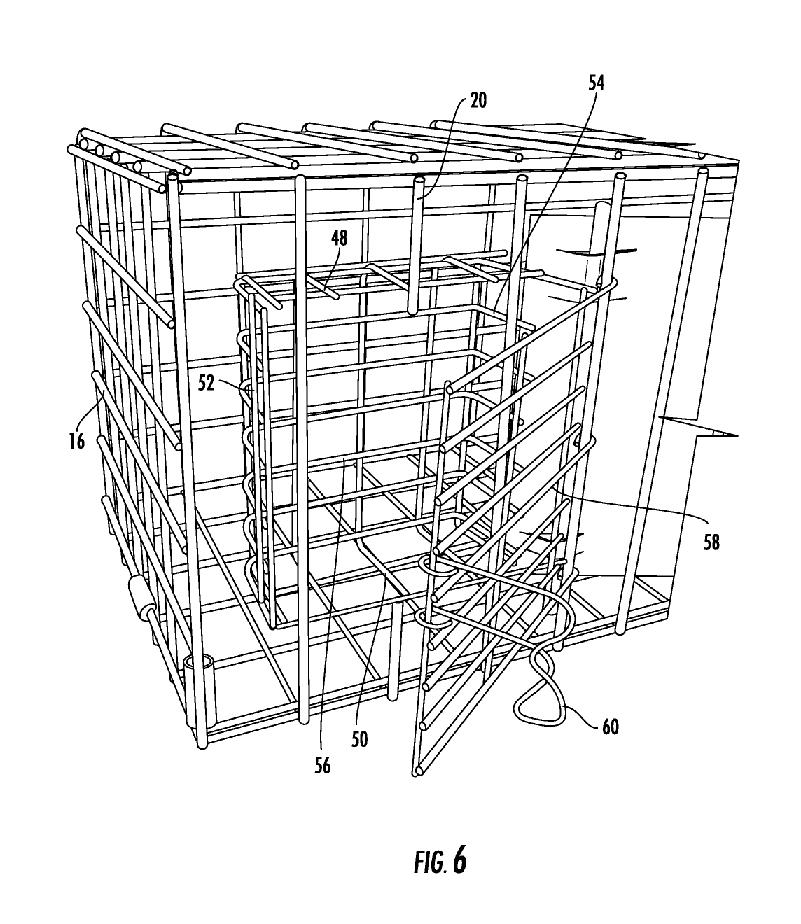

FIG. 6 shows a partial bottom view of trap 10 showing a bait chamber formed within bottom wall 20 to trap 10. As shown, an opening in bottom wall 20 is surrounded by a first sidewall 48, a second sidewall 50, a third sidewall 52 and a fourth sidewall 54. A roof wall 58 joins sidewalls 48, 50, 52, and 54 to form a bait chamber. Sidewalls 48, 50, 52, and 54 extend into the interior chamber of trap 10 such that bait placed in the bait chamber will attract animals into the trap 10. It will be understood that any of bait chamber walls, roof and door are formed of formed of a series of connected bars. The bars allow an animal to both see and smell the bait contained therein.

A hinged bait chamber access door 58 mounted to the underside of the trap 10 is used to selectively close the bait chamber and provide access thereto. A fastening mechanism 60 or lock provided on bait chamber access door 58 is used to temporarily secure the bait chamber access door 58 in a closed position.

In a preferred embodiment, the bait chamber is positioned at the far end of the trap 10. In embodiments of the invention, for example, the bait chamber is situated between the trigger plate 32 and the rear wall 16 of the trap 10. In this respect, an animal will need to step on trigger plate 32 when advancing toward the bait chamber.

In use, to load bait into the trap 10, a user opens bait chamber access door 58, inserts bait into the bait chamber, and then closes the bait chamber access door 58 and secures the fastening mechanism 60.Thereafter, the user places the trap 10 bottom-side down on the ground or similar surface. The user then sets the trap by raising the trap door 24 and engages hook 26 to temporarily secure the door 24 in a raised position as described above. An animal (e.g. squirrel, raccoon, ground hog, skunk, etc.) sensing the bait in the bait chamber will walk in through opening 22 and into the trap interior. When the animal steps on the trigger plate 32, the door 24 will be released and it will automatically close—thereby trapping the animal unharmed inside the confines of the trap.

It will be understood that traps may be formed in any of various sizes in different embodiments of the invention. For instance, different sized traps may be used to target different animals. In one exemplary embodiment of the invention, a trap configured to trap squirrels is around 5″ high, 5″ wide and 18″-22″ long. However, these dimensions can be varied depending upon the size of the animal for which the trap is intended.

Having described this invention with regard to specific embodiments, it is to be understood that the description is not meant as a limitation since further modifications and variations may be apparent or may suggest themselves to those skilled in the art. It is intended that the present application cover all such modifications and variations.

What is claimed is:

1) An animal trap, comprising:
two substantially opposing sidewalls, a rear wall, a top wall, a bottom wall and an opening defining an interior trap chamber;
a trap door having a first end hingedly mounted within the trap chamber, whereby the trap door is pivotable from a first substantially diagonal position to a second position substantially parallel to an underside of the top wall;
a bar disposed on the trap door;
a pivotable hook disposed proximate to the top wall, the hook comprising a shaft segment and a pocket configured to receive the bar disposed on the trap door;
a trigger plate hingedly mounted within the interior trap chamber, the trigger plate disposed at an angle;
a crossbar having a first end in contact with the trigger plate and a second end in contact the hook, whereby movement of the trigger plate imparts movement to the crossbar and the hook, such that hook pivots to release the bar disposed on the trap door.

2) The animal trap of claim 1, further comprising a spring mounted to the second end of the crossbar, the spring biasing the crossbar in a first direction.

3) The animal trap of claim 1, whereby the pivotable hook comprises a hole through the shaft segment, the hole being mounted on an axle.

4) The animal trap of claim 1, further comprising a projection extending upwardly from the pivotable hook.

5) The animal trap of claim 4, whereby the projection is sized and shaped to interface with a user's thumb.

6) The animal trap of claim 1, further comprising a secondary hook mounted on the trap door, the secondary hook configured to secure the trap door in the second position.

7) The animal trap of claim 6, whereby the secondary hook comprises a lower aspect pivotably mounted to the trap door and an upper hook segment configured to capture a a segment of the top wall.

8) The animal trap of claim 1, further comprising a bait chamber, the bait chamber comprising a walled area within the interior trap chamber.

9) The animal trap of claim 8, whereby the bait chamber comprises an opening in the bottom wall of the trap and walls extending from the opening, whereby the walls are joined by a roof wall.

10) The animal trap of claim 9, further comprising a bait chamber access door.

11) The animal trap of claim 10, whereby the bait chamber access door further comprises a fastening mechanism.
